(19) United States
(12) Patent Application Publication
(10) Pub. No.: US 2026/0291539 A1
(43) Pub. Date: Sep. 24, 2026

(54) MULTI-COMMUNICATION DEVICE

(71) Applicant: UNIQCONN INC., Seongnam-si, Gyeonggi-do (KR)

(72) Inventors: Young Dong KIM, Hwaseong-si (KR); Dong Hun SHIN, Anyang-si (KR); Choong Sik LEE, Pohang-si (KR); Oh Seog CHOI, Hwaseong-si (KR); Dong Hun OH, Ansan-si (KR); Myung Hwa KIM, Hwaseong-si (KR)

(73) Assignee: UNIQCONN INC., Seongnam-si, Gyeonggi-do (KR)

(21) Appl. No.: 19/571,672

(22) Filed: Mar. 19, 2026

(30) Foreign Application Priority Data
Mar. 20, 2025 (KR) 10-2025-0035999

(51) Int. Cl. H04B 1/40

(52) U.S. Cl. CPC H04B 1/40

(57) ABSTRACT

The present disclosure is related to an antenna. A multi-communication device according to an embodiment of the present disclosure includes a first mechanical unit, a second mechanical unit spaced apart from a lower portion of the first mechanical unit and configured to rotate relative to the first mechanical unit, a first communication module including a first transmitter configured to transmit a signal with a first circular polarization and a first receiver configured to receive a signal with a second circular polarization, a second communication module including a second transmitter configured to transmit a signal with the second circular polarization and a second receiver configured to receive a signal with the first circular polarization, a third communication module including a third transmitter configured to transmit a signal with the second circular polarization and a third receiver configured to receive a signal with the first circular polarization.

### CROSS-REFERENCE TO RELATED APPLICATION

This application claims priority to and the benefit of Korean Patent Application No. 10-2025-0035999, filed on Mar. 20, 2025, the disclosure of which is incorporated herein by reference in its entirety.

### BACKGROUND

### 1. Field of the Invention

The present disclosure relates to a multi-communication device, and more particularly, to a multi-communication device including a plurality of communication modules that transmit and receive circularly polarized signals.

### 2. Discussion of Related Art

Recently, various devices have been capable of performing short-range communication by utilizing various communication technologies. In particular, devices that perform various operations, such as medical devices and robots, utilize wireless communication technology to control the operations of their mechanical units.

Wireless communication technology controls mechanical units through transmission and reception antennas located in each component. Such wireless communication technology is highly useful for various mechanical units that perform complex operations, such as 360-degree rotations, in that communication is possible even between mechanically independent mechanical units. However, since the above-described wireless communication technology does not transmit communication signals in a wired manner, there may be disadvantages such as interference from external signals and interference between communication signals of the antennas.

To overcome these disadvantages, a dual-circular-polarization (DCP) antenna communication module has been developed. The DCP antenna communication module is an antenna that transmits and receives circularly polarized signals, such as right-hand-circularly polarized (RHCP) signals and left-hand-circularly polarized (LHCP) signals. Such a DCP antenna communication module has an advantage in that it can minimize interference between antenna signals by transmitting and receiving polarized signals that rotate in respective directions.

Meanwhile, with the advancement of technology, devices in various advanced industrial fields are demanding wireless communication technology capable of transmitting and receiving a larger amount of data simultaneously to perform more precise and complex operations. A plurality of DCP antenna communication modules may be one solution to address these demands.

However, even in multi-communication devices equipped with a plurality of DCP antenna communication modules, signal interference remains a problem that is difficult to resolve. In addition, a signal transmitted from a transmitter of a single DCP antenna communication module may be received by a receiver of a third DCP antenna communication module due to rotational motions of mechanical units.

Therefore, to address the above-described problems, a multi-communication device according to the present disclosure will be described below.

Meanwhile, the discussion of related art described above represents technical information possessed by the inventors for the purpose of developing the present disclosure or acquired during the process of developing the present disclosure. Therefore, it does not necessarily constitute technology that was publicly known prior to the filing date of the present disclosure.

### RELATED ART DOCUMENT

### Patent Document

(Patent Document 1) Korean Laid-Open Patent No. 10-2024-0013276 (Published Jan. 30, 2024)

### SUMMARY OF THE INVENTION

The present disclosure is directed to providing a multi-communication device that reduces signal interference between a plurality of communication modules.

The present disclosure is also directed to providing a multi-communication device that addresses the problem of a transmission signal transmitted from a transmitter of a single communication module being received by receivers of a plurality of communication modules within a device due to the absence of a reference signal.

The present disclosure is also directed to providing a multi-communication device that reduces communication errors occurring between a plurality of communication modules disposed in each mechanical unit due to the rotational motion of each mechanical unit in which the communication modules are installed.

The present disclosure is also directed to providing a multi-communication device in which a larger number of communication modules can be disposed within a limited space.

The technical problems of the present disclosure are not limited to the technical problems mentioned above, and other technical problems that are not mentioned will be clearly understood by those skilled in the art from the following description.

According to an embodiment of the present disclosure, there is provided a multi-communication device which includes a first mechanical unit; a second mechanical unit spaced apart from a lower portion of the first mechanical unit and configured to rotate relative to the first mechanical unit; a first communication module including a first transmitter configured to transmit a signal with a first circular polarization and a first receiver configured to receive a signal with a second circular polarization; a second communication module including a second transmitter configured to transmit a signal with a second circular polarization and a second receiver configured to receive a signal with the first circular polarization; a third communication module including a third transmitter configured to transmit a signal with the second circular polarization and a third receiver configured to receive a signal with the first circular polarization; and a fourth communication module including a fourth transmitter configured to transmit a signal with the first circular polarization and a fourth receiver configured to receive a signal with the second circular polarization, wherein the first communication module and the third communication module are disposed on the lower portion of the first mechanical unit, and the second communication module and the fourth communication module are disposed on an upper portion of the second mechanical unit.

In the multi-communication device according to another embodiment of the present disclosure, the first communication module may communicate only with the second communication module, and the third communication module may communicate only with the fourth communication module.

In the multi-communication device according to another embodiment of the present disclosure, at least one pair of communication modules among the first and third communication modules and the second and fourth communication modules may be disposed on a single printed circuit board.

In the multi-communication device according to another embodiment of the present disclosure, the communication modules disposed on the same surface of one mechanical unit may be spaced apart from each other by a predetermined distance, and the predetermined distance may be three to five times a wavelength determined based on a center frequency of the communication modules.

In the multi-communication device according to another embodiment of the present disclosure, the first mechanical unit may perform a rotational motion about a central axis parallel to a central axis about which the second mechanical unit rotates.

In the multi-communication device according to another embodiment of the present disclosure, the multi-communication device may further include a third mechanical unit spaced apart from a lower portion of the second mechanical unit; a fifth communication module including a fifth transmitter configured to transmit a signal with the first circular polarization and a fifth receiver configured to receive a signal with the second circular polarization; a sixth communication module including a sixth transmitter configured to transmit a signal with the second circular polarization and a sixth receiver configured to receive a signal with the first circular polarization; a seventh communication module including a seventh transmitter configured to transmit a signal with the second circular polarization and a seventh receiver configured to receive a signal with the first circular polarization; an eighth communication module including an eighth transmitter configured to transmit a signal with the first circular polarization and an eighth receiver configured to receive a signal with the second circular polarization; and a sidewall disposed along outer peripheries of the first mechanical unit and the third mechanical unit, spaced apart from an outer circumference of the second mechanical unit, and surrounding the second mechanical unit, wherein the fifth communication module and the seventh communication module are disposed on an upper portion of the third mechanical unit, and the sixth communication module and the eighth communication module are disposed on a lower portion of the second mechanical unit.

In the multi-communication device according to another embodiment of the present disclosure, each of the second mechanical unit and the third mechanical unit may be provided as a plurality of mechanical units.

In the multi-communication device according to another embodiment of the present disclosure, the sixth communication module may be disposed on a lower surface of the second mechanical unit at a position corresponding to the second communication module, and the eighth communication module may be disposed on the lower surface of the second mechanical unit at a position corresponding to the fourth communication module.

In the multi-communication device according to another embodiment of the present disclosure, the first communication module may communicate only with the second communication module, the third communication module may communicate only with the fourth communication module, the fifth communication module may communicate only with the sixth communication module, and the seventh communication module may communicate only with the eighth communication module.

In the multi-communication device according to another embodiment of the present disclosure, at least one pair of communication modules among the first and third communication modules, the second and fourth communication modules, the fifth and seventh communication modules, and the sixth and eighth communication modules may be disposed on a single printed circuit board.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic cross-sectional view showing a multi-communication device according to an embodiment of the present disclosure;

FIG. 2 is a schematic plan view showing the multi-communication device of FIG. 1 in direction II;

FIG. 3 is a schematic plan view showing the multi-communication device of FIG. 1 in direction III;

FIG. 4 is a schematic cross-sectional view showing a multi-communication device according to another embodiment of the present disclosure;

FIG. 5 is a schematic plan view showing the multi-communication device of FIG. 4 in direction V; and

FIG. 6 is a schematic cross-sectional view showing a multi-communication device according to another embodiment of the present disclosure.

### DETAILED DESCRIPTION OF EXEMPLARY EMBODIMENTS

The advantages and features of the present disclosure, and the methods for achieving them, will become clear with reference to the embodiments described in detail below together with the accompanying drawings. However, the present disclosure is not limited to the embodiments disclosed below, but may be implemented in various different forms, and these embodiments are provided only to make the disclosure of the present disclosure complete and to fully inform those skilled in the art of the scope of the invention, and the present disclosure is defined only by the scope of the claims.

The shapes, sizes, ratios, angles, numbers, etc., disclosed in the drawings for explaining the embodiment in the present specification are exemplary, and the embodiments of the present specification are not limited to the illustrated points. In addition, in describing the embodiment, when it is determined that a detailed description of a related known technology may unnecessarily obscure the gist of the embodiment, the detailed description thereof will be omitted. When the terms “include,” “have,” “consist,” “comprise,” etc., are used herein, it should be understood that other parts or elements may be added unless “only” is used. When an element is expressed in the singular, it may be understood to include the plural unless specifically stated otherwise.

In addition, the elements should be interpreted as including an error range even when there is no separate explicit description.

When terms such as “first,” “second,” and the like are used herein to describe various elements or components, these elements or components are not limited by these terms. These terms are merely used herein for distinguishing one element from another element. Therefore, a first element described below may be a second element within the technical spirit of the present disclosure.

Unless otherwise specified, like reference numerals refer to like elements throughout the specification.

The features of each of the embodiments of the present specification may be partially or fully combined or coupled with each other, and as will be readily understood by those skilled in the art, technically, various interconnections and operations are possible. In addition, the embodiments may be implemented independently of each other or may be implemented together in a related relationship.

Hereinafter, a multi-communication device according to embodiments of the present disclosure will be described in detail with reference to the accompanying drawings.

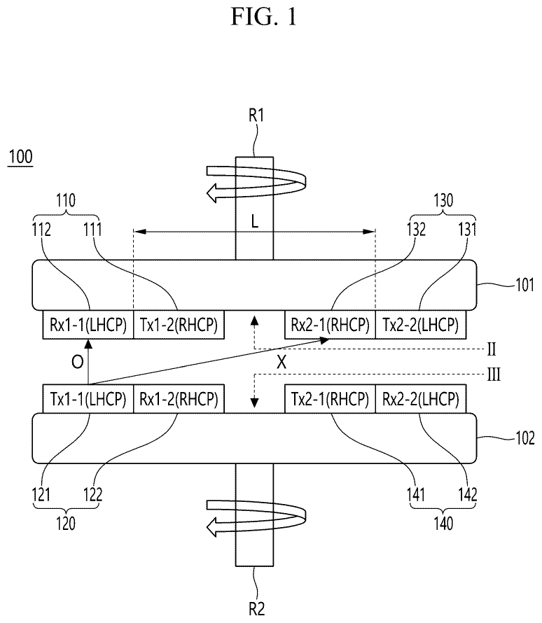

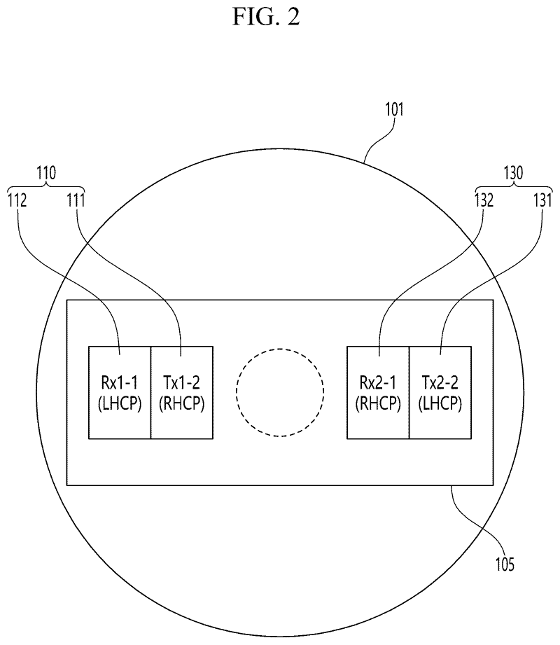

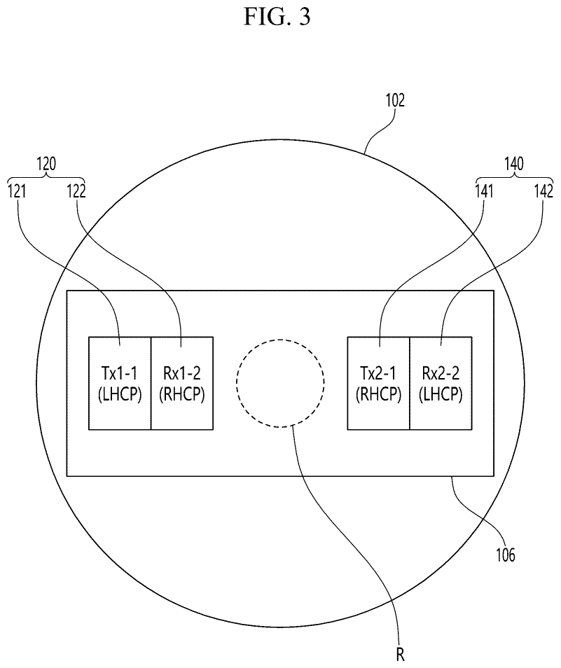

FIG. 1 is a schematic cross-sectional view showing a multi-communication device 100 according to an embodiment of the present disclosure. FIG. 2 is a schematic plan view showing the multi-communication device 100 of FIG. 1 in direction II. FIG. 3 is a schematic plan view showing the multi-communication device 100 of FIG. 1 in direction III.

Referring to FIGS. 1 to 3, a multi-communication device 100 according to an embodiment of the present disclosure includes a first mechanical unit 101, a second mechanical unit 102, and first to fourth communication modules 110 to 140. The first communication module 110 includes a first transmitter 111 and a first receiver 112, the second communication module 120 includes a second transmitter 121 and a second receiver 122, the third communication module 130 includes a third transmitter 131 and a third receiver 132, and the fourth communication module 140 includes a fourth transmitter 141 and a fourth receiver 142.

The first mechanical unit 101 may be provided as a part of a specific device or may be installed on a specific device. In particular, the first mechanical unit 101 may protrude from a portion of the specific device or may be disposed at an end of the specific device. For example, the first mechanical unit 101 may be disposed at an end of a device such as a robot arm. Such a first mechanical unit 101 may have a plate-like shape. Meanwhile, the communication modules 110 and 130 of the multi-communication device 100 may be disposed on one surface of the first mechanical unit 101.

The first mechanical unit 101 may be fixed to an end of a specific device. However, the present disclosure is not limited thereto, and the first mechanical unit 101 may perform a rotational motion about a central axis R1 of the first mechanical unit 101. Meanwhile, a rotational speed of the first mechanical unit 101 may be adjusted depending on a predetermined value.

The second mechanical unit 102 may be provided as a part of a specific device or may be installed on a specific device. In particular, the second mechanical unit 102 may protrude from a portion of the specific device or may be disposed at an end of the specific device. The second mechanical unit 102 may have a plate-like shape. Meanwhile, the communication modules 120 and 140 of the multi-communication device 100 may be disposed on one surface of the second mechanical unit 102.

The second mechanical unit 102 may be disposed at a position corresponding to the first mechanical unit 101. In addition, the second mechanical unit 102 may be spaced apart from a lower portion of the first mechanical unit 101 by a predetermined distance. Accordingly, physical contact between the first mechanical unit 101 and the second mechanical unit 102 may be prevented. Furthermore, the second mechanical unit 102 may operate independently of the first mechanical unit 101.

The second mechanical unit 102 may perform a rotational motion about a central axis R2 of the second mechanical unit 102. In this case, the central axis R2 of the second mechanical unit 102 may be disposed parallel to a central axis R1 of the first mechanical unit 101. Preferably, the central axis R2 of the second mechanical unit 102 may be collinear with the central axis R1 of the first mechanical unit 101.

Meanwhile, the rotational speed of the second mechanical unit 102 may be different from the rotational speed of the first mechanical unit 101. Furthermore, the second mechanical unit 102 may rotate in a direction opposite to that of the first mechanical unit 101. Meanwhile, the rotational speed of the second mechanical unit 102 may be adjusted depending on a predetermined value.

The first communication module 110 and the third communication module 130 may be disposed on a lower portion of the first mechanical unit 101. Referring to FIG. 1, the first communication module 110 and the third communication module 130 may be attached to or mounted on the lower surface of the first mechanical unit 101. In addition, the first communication module 110 and the third communication module 130 may be spaced apart from each other by a predetermined separation distance L. Preferably, each of the first communication module 110 and the third communication module 130 may be spaced apart from the central axis R1 of the first mechanical unit 101 by the same distance.

The second communication module 120 and the fourth communication module 140 may be disposed on an upper portion of the second mechanical unit 102. Referring to FIG. 1, the second communication module 120 and the fourth communication module 140 may be attached to or mounted on the upper surface of the second mechanical unit 102. In addition, the second communication module 120 and the fourth communication module 140 may be spaced apart from each other by a predetermined separation distance. Preferably, each of the second communication module 120 and the fourth communication module 140 may be spaced apart from the central axis R2 of the second mechanical unit 102 by the same distance. Here, the separation distance L between the second communication module 120 and the fourth communication module 140 may be the same as the separation distance L between the first communication module 110 and the third communication module 130. In this manner, the second communication module 120 and the fourth communication module 140 may be vertically spaced apart from each other at a position where the second communication module 120 and the fourth communication module 140 face the first communication module 110 and the third communication module 130, respectively.

The separation distance L between the first communication module 110 and the third communication module 130 disposed on the same surface of the first mechanical unit 101 may be three to five times a wavelength determined based on a center frequency of the communication modules 110 to 140 and preferably may be four times the wavelength. In addition, the separation distance L between the second communication module 120 and the fourth communication module 140 disposed on the same surface of the second mechanical unit 102 may be three to five times the wavelength determined based on a center frequency of the communication modules 110 to 140, and preferably may be four times the wavelength.

Meanwhile, a separation distance between the first communication module 110 and the second communication module 120 and a separation distance between the third communication module 130 and the fourth communication module 140 may be determined according to a communicable range of each communication module. However, the separation distance between the first communication module 110 and the second communication module 120 and the separation distance between the third communication module 130 and the fourth communication module 140 may be the same.

Each of the transmitters 111 to 141 and the receivers 112 to 142 may transmit and receive circularly polarized signals. Here, the circularly polarized signals are signals in which an electric field vector rotates while tracing a circular trajectory over time. Such circularly polarized signals may be classified into right-hand circularly polarized (RHCP) signals in which the electric field vector rotates clockwise and left-hand circularly polarized (LHCP) signals in which the electric field vector rotates counterclockwise. Hereinafter, for convenience of description, the RHCP signal is defined as a first circular polarization, and the LHCP signal is defined as a second circular polarization. However, these definitions are provided merely for convenience of description, and thus the LHCP signal may be the first circularly polarized signal and the RHCP signal may be the second circularly polarized signal.

Specifically, the first transmitter 111 and the fourth transmitter 141 may transmit signals with the first circular polarization. In addition, the second transmitter 121 and the third transmitter 131 may transmit signals with the second circular polarization. Meanwhile, the first receiver 112 and the fourth receiver 142 may receive signals with the second circular polarization, and the second receiver 122 and the third receiver 132 may receive signals with the first circular polarization. Accordingly, signals transmitted from the first transmitter 111 may be received by the second receiver 122, and signals transmitted from the second transmitter 121 may be received by the first receiver 112. In the same manner, signals transmitted from the third transmitter 131 may be received by the fourth receiver 142, and signals transmitted from the fourth transmitter 141 may be received by the third receiver 132.

On the other hand, when one of the first mechanical unit 101 and the second mechanical unit 102 is rotated 180 degrees, the first communication module 110 may be disposed to face the fourth communication module 140, and the third communication module 130 may be disposed to face the second communication module 120. In this case, a first circularly polarized signal transmitted from the first transmitter 111 cannot be received by the fourth receiver 142 configured to receive a signal with a different circular polarization. In addition, a first circularly polarized signal transmitted from the fourth transmitter 141 cannot be received by the first receiver 112 configured to receive a signal with a different circular polarization. Similarly, a second circularly polarized signal transmitted from the third transmitter 131 cannot be received by the second receiver 122 configured to receive a signal with a different circular polarization, and a second circularly polarized signal transmitted from the second transmitter 121 cannot be received by the third receiver 132 configured to receive a signal with a different circular polarization. As described above, since the first communication module 110 includes the first transmitter 111 configured to transmit a signal with the first circular polarization and the first receiver 112 configured to receive a signal with the second circular polarization, the first communication module 110 cannot communicate with the fourth communication module 140, which includes the fourth receiver 142 configured to receive a signal with the second circular polarization and the fourth transmitter 141 configured to transmit a signal with the first circular polarization. Similarly, since the third communication module 130 includes the third transmitter 131 configured to transmit a signal with the second circular polarization and the third receiver 132 configured to receive a signal with the first circular polarization, the third communication module 130 cannot communicate with the second communication module 120, which includes the second receiver 122 configured to receive a signal with the first circular polarization and the second transmitter 121 configured to transmit a signal with the second circular polarization. That is, even when the first communication module 110 and the fourth communication module 140 are disposed to face each other while the mechanical units rotate, the first communication module 110 and the fourth communication module 140 cannot communicate with each other because circular polarizations used for transmission and reception are different from each other. Similarly, even when the third communication module 130 and the second communication module 120 are disposed to face each other while the mechanical units rotate, the third communication module 130 and the second communication module 120 cannot communicate with each other because circular polarizations used for transmission and reception are different from each other.

Accordingly, since the first communication module 110 includes the first transmitter 111 configured to transmit a signal with the first circular polarization and the first receiver 112 configured to receive a signal with the second circular polarization, the first communication module 110 may communicate only with the second communication module 120, which includes the second receiver 122 configured to receive a signal with the first circular polarization and the second transmitter 121 configured to transmit a signal with the second circular polarization. Similarly, since the third communication module 130 includes the third transmitter 131 configured to transmit a signal with the second circular polarization and the third receiver 132 configured to receive a signal with the first circular polarization, the third communication module 130 may communicate only with the fourth communication module 140, which includes the fourth receiver 142 configured to receive a signal with the second circular polarization and the fourth transmitter 141 configured to transmit a signal with the first circular polarization. Consequently, even when one of the first mechanical unit 101 and the second mechanical unit 102 is rotated 180 degrees, the transmitter of the first mechanical unit 101 and the receiver of the second mechanical unit 102 may communicate with each other only when they use the same circular polarization.

Referring to FIGS. 2 and 3, a first printed circuit board 105 may be disposed on a lower surface of the first mechanical unit 101, and a second printed circuit board 106 may be disposed on an upper surface of the second mechanical unit 102. In addition, the first communication module 110 and the third communication module 130 may be disposed on the first printed circuit board 105, and the second communication module 120 and the fourth communication module 140 may be disposed on the second printed circuit board 106. Here, the first printed circuit board 105 and the second printed circuit board 106 include circuit wirings for supplying electrical signals to respective communication modules 110, 120, 130, and 140 mounted on the first printed circuit board 105 and the second printed circuit board 106.

Meanwhile, in FIG. 2, the first communication module 110 and the third communication module 130 are illustrated as being integrally formed with the first printed circuit board 105, but the first communication module 110 and the third communication module 130 may be disposed in respective regions of the first printed circuit board 105 that is divided into two portions. In addition, in FIG. 3, the second communication module 120 and the fourth communication module 140 are illustrated as being integrally formed with the second printed circuit board 106, but the second communication module 120 and the fourth communication module 140 may be disposed in respective regions of the second printed circuit board 106 that is divided into two portions. Further, in FIGS. 2 and 3, the first printed circuit board 105 and the second printed circuit board 106 are illustrated as having a rectangular shape, but the present disclosure is not limited thereto, and each of the first printed circuit board 105 and the second printed circuit board 106 may have a circular shape, an elliptical shape, or a polygonal shape.

In the multi-communication device 100 according to an embodiment of the present disclosure, since types of circular polarizations of signals are previously determined for the transmitters 111 to 141 and the receivers 112 to 142, wireless communication is possible only between predetermined communication modules among the plurality of communication modules 110 to 140. For example, wireless communication may be possible only between the first communication module 110 and the second communication module 120. Similarly, in the multi-communication device 100, wireless communication may be possible only between the third communication module 130 and the fourth communication module 140. For example, despite rotational motions of the first mechanical unit 101 and the second mechanical unit 102, a signal transmitted from the transmitter 121 of the second communication module 120 may be received only by the receiver 112 of the first communication module 110, and may not be received by the receiver 132 of the third communication module 130. Accordingly, the multi-communication device 100 may transmit and receive signals only between specific communication modules according to predetermined directions of circular polarizations. Therefore, the multi-communication device 100 can prevent wireless communication with communication modules other than the specific communication modules. Furthermore, despite rotational motions of the mechanical units, the multi-communication device 100 can reduce signal interference among the communication modules 110 to 140, and as a result, communication errors can be reduced.

Meanwhile, in the multi-communication device 100 according to an embodiment of the present disclosure, by limiting the separation distance L between the first communication module 110 and the third communication module 130 to three to five times a wavelength determined based on a center frequency of the communication modules 110 to 140, interference between circularly polarized signals between the first communication module 110 and the third communication module 130 disposed on the same surface can be reduced. Similarly, in the multi-communication device 100, by limiting the separation distance L between the second communication module 120 and the fourth communication module 140 to three to five times a wavelength determined based on a center frequency of the communication modules 110 to 140, interference between circularly polarized signals between the second communication module 120 and the fourth communication module 140 disposed on the same surface can be reduced. Accordingly, the multi-communication device 100 can reduce communication errors between the first communication module 110 and the third communication module 130 disposed on the same surface, as well as communication errors between the second communication module 120 and the fourth communication module 140 disposed on the same surface.

In addition, since the multi-communication device 100 according to an embodiment of the present disclosure includes a plurality of communication modules 110 to 140 that perform wireless communication, data may be transmitted and received in parallel for each of the communication modules 110 to 140, and a large amount of data may be processed simultaneously. Consequently, the multi-communication device 100 may perform high-bit-rate communication by rapidly processing a large amount of data through the plurality of communication modules 110 to 140. Furthermore, devices utilizing the multi-communication device 100 may perform complex operations without operational delays or operational errors through such high-bit-rate communication.

In the multi-communication device 100 according to an embodiment of the present disclosure, wireless communication may be performed through the communication modules 110 and 130 disposed on the first mechanical unit 101 and the second mechanical unit 102. Accordingly, a device on which the first mechanical unit 101 is disposed and another device on which the second mechanical unit 102 is disposed may perform operations without physical contact with each other. Through this, the multi-communication device 100 can prevent damage to the devices, such as wear between devices that may occur during device operation. In addition, according to such a multi-communication device 100, device maintenance costs can be reduced.

Since the multi-communication device 100 according to an embodiment of the present disclosure includes the first mechanical unit 101 and the second mechanical unit 102 that rotate at different rotational speeds and in different rotational directions, various combinations of angular velocities between the first mechanical unit 101 rotating at a first angular velocity and the second mechanical unit 102 rotating at a second angular velocity may be configured. Furthermore, by configuring various combinations of angular velocities, operational versatility of the multi-communication device 100 can be increased.

Since the multi-communication device 100 according to an embodiment of the present disclosure includes the communication modules 110 to 140 including the transmitters 111 to 141 and the receivers 112 to 142, respectively, the multi-communication device 100 may be manufactured with a smaller number of communication modules than a configuration using separate transmission and reception communication modules. Therefore, manufacturing costs for the multi-communication device 100 can be reduced.

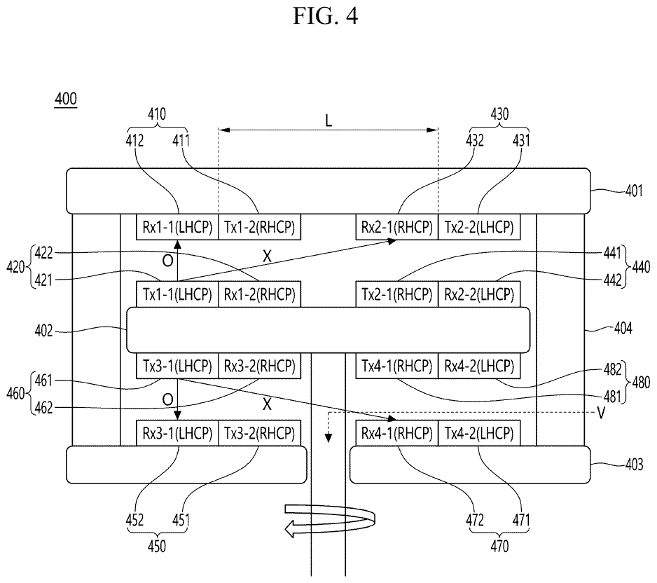

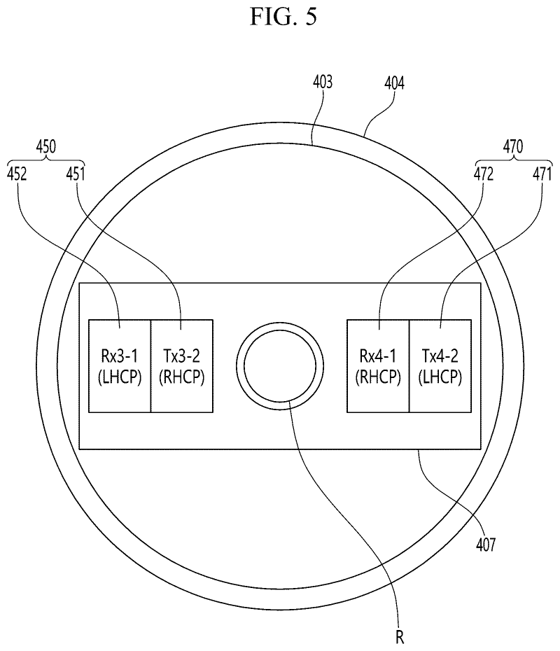

FIG. 4 is a schematic cross-sectional view showing a multi-communication device 400 according to another embodiment of the present disclosure. FIG. 5 is a schematic plan view showing the multi-communication device 400 of FIG. 4 in direction V. Meanwhile, configurations illustrated in FIG. 4 differ from those illustrated in FIG. 1 only in a third mechanical unit 403, a sidewall 404, and fifth to eighth communication modules 450 to 480, and the remaining configurations are substantially the same. Therefore, redundant descriptions will be omitted, and the remaining configurations will be described below.

Referring to FIGS. 4 and 5, the multi-communication device 400 according to another embodiment of the present disclosure may further include the third mechanical unit 403, the sidewall 404, and the fifth to eighth communication modules 450 to 480. In addition, the fifth communication module 450 may include a fifth transmitter 451 and a fifth receiver 452, the sixth communication module 460 may include a sixth transmitter 461 and a sixth receiver 462, the seventh communication module 470 may include a seventh transmitter 471 and a seventh receiver 472, and the eighth communication module 480 may include an eighth transmitter 481 and an eighth receiver 482.

The third mechanical unit 403 may be disposed at a position corresponding to the first mechanical unit 401 and the second mechanical unit 402. In addition, the third mechanical unit 403 may be spaced apart from a lower portion of the second mechanical unit 402. Accordingly, physical contact may not occur between the second mechanical unit 402 and the third mechanical unit 403, and thus the second mechanical unit 402 and the third mechanical unit 403 may operate independently of each other. Meanwhile, the first mechanical unit 401 and the third mechanical unit 403 may be connected to each other via the sidewall 404. Here, the sidewall 404 may surround the second mechanical unit 402 along outer peripheries of the first mechanical unit 401 and the third mechanical unit 403, and the sidewall 404 may be spaced apart from an outer periphery of the second mechanical unit 402. Accordingly, rotational motions of the first mechanical unit 401 and the third mechanical unit 403 may not physically affect the second mechanical unit 402. Meanwhile, the third mechanical unit 403 may have a plate-like shape, and the communication modules 450 and 470 of the multi-communication device 400 may be disposed on one surface of the third mechanical unit 403.

The third mechanical unit 403 may be fixed to the device together with the first mechanical unit 401 connected via the sidewall 404 or may perform a rotational motion. In this case, the first mechanical unit 401 and the third mechanical unit 403 may operate independently of the second mechanical unit 402. With such an arrangement, the first mechanical unit 401 and the third mechanical unit 403 may be disposed at the end of a different device from the second mechanical unit 402. For example, the first mechanical unit 401 and the third mechanical unit 403 may be disposed at an end of one robot arm, and the second mechanical unit 402 may be disposed at an end of another robot arm. Accordingly, the robot arm on which the first mechanical unit 401 and the third mechanical unit 403 are disposed and the robot arm on which the second mechanical unit 402 is disposed may operate at different rotational speeds and in different rotational directions from each other. Meanwhile, the multi-communication device 400 may further include, in addition to the communication modules 410 to 480, an input module, a processing module, or an output module, thereby enabling more various operations. Such input module, processing module, and output module may be disposed on one surface of the first to third mechanical units 401 to 403.

The fifth communication module 450 and the seventh communication module 470 may be disposed on an upper portion of the third mechanical unit 403. Referring to FIG. 4, the fifth communication module 450 and the seventh communication module 470 may be attached to or mounted on an upper surface of the third mechanical unit 403. In addition, the fifth communication module 450 and the seventh communication module 470 may be spaced apart from each other by a predetermined separation distance L.

The sixth communication module 460 and the eighth communication module 480 may be disposed on a lower portion of the second mechanical unit 402. Referring to FIG. 4, the sixth communication module 460 and the eighth communication module 480 may be attached to or mounted on a lower surface of the second mechanical unit 402. In addition, the sixth communication module 460 and the eighth communication module 480 may be spaced apart from each other by a predetermined separation distance L. Preferably, each of the sixth communication module 460 and the eighth communication module 480 may be spaced apart by the same distance from a central axis R2 of the second mechanical unit 402. Furthermore, the sixth communication module 460 may be disposed at a position corresponding to the second communication module 420, and the eighth communication module 480 may be disposed at a position corresponding to the fourth communication module 440. Here, the separation distance L between the sixth communication module 460 and the eighth communication module 480 may be the same as the separation distance L between the fifth communication module 450 and the seventh communication module 470. Accordingly, the sixth communication module 460 and the eighth communication module 480 may be disposed to face the fifth communication module 450 and the seventh communication module 470, respectively.

Meanwhile, a separation distance L between the sixth communication module 460 and the eighth communication module 480 disposed on the same surface of the second mechanical unit 402 may be three to five times a wavelength determined based on a center frequency of the communication modules 410 to 480, and preferably four times the wavelength. In addition, a separation distance L between the fifth communication module 450 and the seventh communication module 470 disposed on the same surface of the third mechanical unit 403 may be three to five times a wavelength determined based on a center frequency of the communication modules 410 to 480, and preferably four times the wavelength.

Meanwhile, a separation distance between the fifth communication module 450 and the sixth communication module 460 and a separation distance between the seventh communication module 470 and the eighth communication module 480 may be determined according to the communication ranges of the respective communication modules. However, the separation distance between the fifth communication module 450 and the sixth communication module 460 and the separation distance between the seventh communication module 470 and the eighth communication module 480 may be the same.

Referring to FIG. 5, a third printed circuit board 407 may be disposed on an upper surface of the third mechanical unit 403. In addition, the third printed circuit board 407 may be spaced inward from the sidewall 404 that is in contact with the third mechanical unit 403. The fifth communication module 450 and the seventh communication module 470 may be disposed on the third printed circuit board 407. Meanwhile, in FIG. 5, the fifth communication module 450 and the seventh communication module 470 are illustrated as being integrally formed with the third printed circuit board 407, but the fifth communication module 450 and the seventh communication module 470 may be disposed in respective regions of the third printed circuit board 407 that is divided into two portions. In addition, in FIG. 5, the third printed circuit board 407 is illustrated as having a rectangular shape, but the present disclosure is not limited thereto, and the third printed circuit board 407 may have a circular shape, an elliptical shape, or a polygonal shape.

The fifth transmitter 451 and the eighth transmitter 481 may transmit signals with the first circular polarization, and the sixth transmitter 461 and the seventh transmitter 471 may transmit signals with the second circular polarization. Meanwhile, the fifth receiver 452 and the eighth receiver 482 may receive signals with the second circular polarization, and the sixth receiver 462 and the seventh receiver 472 may receive signals with the first circular polarization. Accordingly, a signal transmitted from the fifth transmitter 451 may be received by the sixth receiver 462, and a signal transmitted from the sixth transmitter 461 may be received by the fifth receiver 452. Similarly, a signal transmitted from the seventh transmitter 471 may be received by the eighth receiver 482, and a signal transmitted from the eighth transmitter 481 may be received by the seventh receiver 472.

On the other hand, when one of the second mechanical unit 402 and the third mechanical unit 403 is rotated 180 degrees, the fifth communication module 450 may be disposed to face the eighth communication module 480, and the seventh communication module 470 may be disposed to face the sixth communication module 460. In this case, a first circularly polarized signal transmitted from the fifth transmitter 451 cannot be received by the eighth receiver 482 configured to receive a signal with a different circular polarization. In addition, the first circularly polarized signal transmitted from the eighth transmitter 481 cannot be received by the fifth receiver 452 configured to receive a signal with a different circular polarization. Similarly, a second circularly polarized signal transmitted from the seventh transmitter 471 cannot be received by the sixth receiver 462 configured to receive a signal with a different circular polarization, and a second circularly polarized signal transmitted from the sixth transmitter 461 cannot be received by the seventh receiver 472 configured to receive a signal with a different circular polarization. As described above, since the fifth communication module 450 includes the fifth transmitter 451 configured to transmit a signal with the first circular polarization and the fifth receiver 452 configured to receive a signal with the second circular polarization, the fifth communication module 450 cannot communicate with the eighth communication module 480, which includes the eighth receiver 482 configured to receive a signal with the second circular polarization and the eighth transmitter 481 configured to transmit a signal with the first circular polarization. Similarly, since the seventh communication module 470 includes the seventh transmitter 471 configured to transmit a signal with the second circular polarization and the seventh receiver 472 configured to receive a signal with the first circular polarization, the seventh communication module 470 cannot communicate with the sixth communication module 460, which includes the sixth receiver 462 configured to receive a signal with the first circular polarization and the sixth transmitter 461 configured to transmit a signal with the second circular polarization. That is, even when the fifth communication module 450 and the eighth communication module 480 are disposed to face each other while the mechanical units rotate, the fifth communication module 450 and the eighth communication module 480 cannot communicate with each other because circular polarizations used for transmission and reception are different from each other. Similarly, even when the seventh communication module 470 and the sixth communication module 460 are disposed to face each other while the mechanical units rotate, the seventh communication module 470 and the sixth communication module 460 cannot communicate with each other because circular polarizations used for transmission and reception are different from each other.

Accordingly, since the fifth communication module 450 includes the fifth transmitter 451 configured to transmit a signal with the first circular polarization and the fifth receiver 452 configured to receive a signal with the second circular polarization, the fifth communication module 450 may communicate only with the sixth communication module 460, which includes the sixth receiver 462 configured to receive a signal with the first circular polarization and the sixth transmitter 461 configured to transmit a signal with the second circular polarization. Similarly, since the seventh communication module 470 includes the seventh transmitter 471 configured to transmit a signal with the second circular polarization and the seventh receiver 472 configured to receive a signal with the first circular polarization, the seventh communication module 470 may communicate only with the eighth communication module 480, which includes the eighth receiver 482 configured to receive a signal with the second circular polarization and the eighth transmitter 481 configured to transmit a signal with the first circular polarization. As a result, even when one of the second mechanical unit 402 and the third mechanical unit 403 rotates 180 degrees, the transmitter of the second mechanical unit 402 and the receiver of the third mechanical unit 403 may communicate only when they use the same circular polarization.

In the multi-communication device 400 according to another embodiment of the present disclosure, since types of circular polarizations of signals are previously determined for the transmitters 411 to 481 and the receivers 412 to 482, wireless communication is possible only between predetermined communication modules among the plurality of communication modules 410 to 480. For example, wireless communication may be performed only between the fifth communication module 450 and the sixth communication module 460. In addition, the multi-communication device 400 may perform wireless communication only between the seventh communication module 470 and the eighth communication module 480. For example, despite rotational motions of the second mechanical unit 402 and the third mechanical unit 403, a signal transmitted from the transmitter 461 of the sixth communication module 460 is received only by the receiver 452 of the fifth communication module 450 and is not received by the receiver 472 of the seventh communication module 470. Accordingly, the multi-communication device 400 can reduce interference between circularly polarized signals among the communication modules 450 to 480 by preventing wireless communication with communication modules other than communication modules configured to communicate with each other. Furthermore, by reducing the interference between circularly polarized signals among the communication modules 450 to 480, the multi-communication device 400 can reduce communication errors among the communication modules 450 to 480.

Meanwhile, in the multi-communication device 400 according to another embodiment of the present disclosure, by limiting a separation distance L between the fifth communication module 450 and the seventh communication module 470 to three to five times a wavelength determined based on a center frequency of the communication modules 410 to 480, interference between circularly polarized signals between the fifth communication module 450 and the seventh communication module 470 disposed on the same surface can be reduced. Similarly, by limiting a separation distance L between the sixth communication module 460 and the eighth communication module 480 to three to five times a wavelength determined based on the center frequency of the communication modules 410 to 480, the multi-communication device 400 can reduce interference between circularly polarized signals between the sixth communication module 460 and the eighth communication module 480 disposed on the same surface. Through this, the multi-communication device 400 can reduce communication errors between the fifth communication module 450 and the seventh communication module 470 disposed on the same surface and can also reduce communication errors between the sixth communication module 460 and the eighth communication module 480 disposed on the same surface.

In addition, the multi-communication device 400 according to another embodiment of the present disclosure may include a signal-to-noise ratio (SNR) budget design structure in which circularly polarized signals of the second communication module 420 and the sixth communication module 460 are set to be the same and circularly polarized signals of the fourth communication module 440 and the eighth communication module 480 are set to be the same. Accordingly, through such an SNR budget design structure, the multi-communication device 400 can prevent wireless communication between the second communication module 420 and the sixth communication module 460 and wireless communication between the fourth communication module 440 and the eighth communication module 480. Through this, the multi-communication device 400 can reduce interference between circularly polarized signals between the second communication module 420 and the sixth communication module 460 and between the fourth communication module 440 and the eighth communication module 480. Furthermore, by reducing such interference between circularly polarized signals, the multi-communication device 400 can reduce communication errors between the second communication module 420 and the sixth communication module 460 and between the fourth communication module 440 and the eighth communication module 480.

Since the multi-communication device 400 according to another embodiment of the present disclosure includes a large number of communication modules 410 to 480, data can be transmitted and received in parallel for each of the communication modules 410 to 480, thereby enabling processing of a larger amount of data simultaneously. Consequently, the multi-communication device 400 can perform high-bit-rate communication by rapidly processing a large amount of data through the plurality of communication modules 410 to 480.

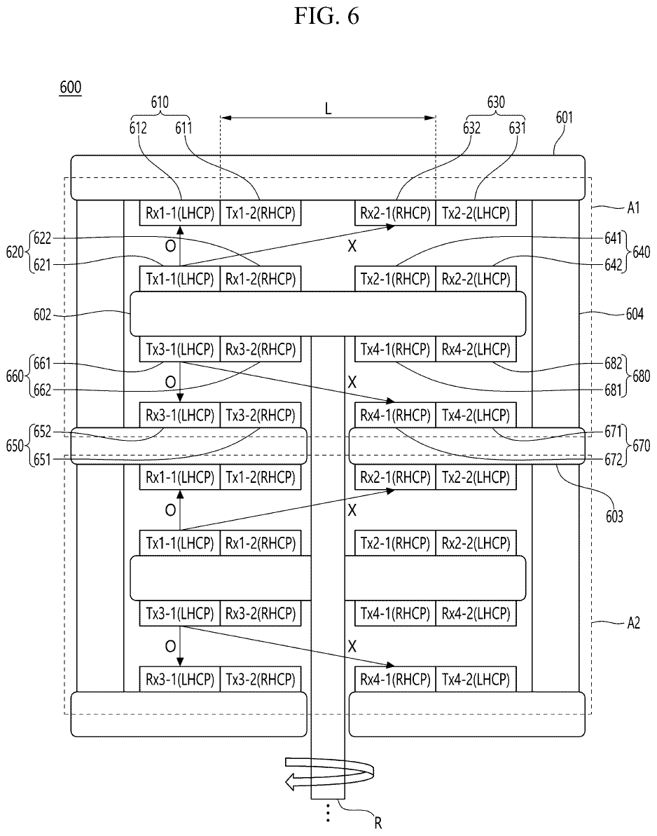

FIG. 6 is a schematic cross-sectional view showing a multi-communication device according to another embodiment of the present disclosure. Referring to FIG. 6, a multi-communication device 600 may have a parallel structure in which a plurality of the multi-communication devices of FIG. 4 are vertically combined. With such an arrangement, the multi-communication device 600 may include a larger number of communication modules 610 to 680.

The multi-communication device 600 according to another embodiment of the present disclosure may include an SNR budget design structure in which circularly polarized signals of the fifth communication module 650 and the first communication module 610 disposed on the third mechanical unit 603 are set to be the same and circularly polarized signals of the seventh communication module 670 and the third communication module 630 disposed on the third mechanical unit 603 are set to be the same. Accordingly, through such an SNR budget design structure, the multi-communication device 600 can prevent wireless communication between the fifth communication module 650 and the first communication module 610 and wireless communication between the seventh communication module 670 and the third communication module 630. Through this, the multi-communication device 600 can reduce interference between circularly polarized signals between the first communication module 610 and the fifth communication module 650 disposed on the third mechanical unit 603, and between the third communication module 630 and the seventh communication module 670 disposed on the third mechanical unit 603. Furthermore, by reducing such interference between circularly polarized signals, the multi-communication device 600 can reduce communication errors between the first communication module 610 and the fifth communication module 650 disposed on the third mechanical unit 603, and communication errors between the third communication module 630 and the seventh communication module 670 disposed on the third mechanical unit 603.

Since the multi-communication device 600 according to another embodiment of the present disclosure includes a large number of communication modules 610 to 680, a larger amount of data can be transmitted and received in parallel, and a larger amount of data can be processed simultaneously. Consequently, the multi-communication device 600 can perform high-bit-rate communication by rapidly processing a large amount of data through the plurality of communication modules 610 to 680.

In addition, the multi-communication device 600 according to another embodiment of the present disclosure includes a vertically parallel arrangement structure of the multi-communication device according to another embodiment of the present disclosure described above with reference to FIG. 4, and thus the multi-communication device 600 can include the plurality of communication modules 610 to 680 within a limited space. Accordingly, the multi-communication device 600 can perform high-capacity and high-speed data communication through the plurality of communication modules 610 to 680. Furthermore, devices in which such a multi-communication device 600 is disposed can perform more precise and complex operations without operational delays or operational errors.

As described above, according to any one of the embodiments for solving the problems of the present disclosure, the multi-communication device can prevent physical contact between mechanical units and damage to devices caused by physical contact by performing wireless communication.

In addition, according to any one of the embodiments for solving the problems of the present disclosure, since the multi-communication device includes a single communication module that includes both a transmitter and a receiver, manufacturing costs of the multi-communication device can be reduced as compared with a case in which separate transmission communication modules and reception communication modules are used.

In addition, according to any one of the embodiments for solving the problems of the present disclosure, since the multi-communication device includes a plurality of communication modules configured to transmit and receive predetermined circularly polarized signals, polarized signal interference occurring among the plurality of communication modules disposed in the multi-communication device can be reduced.

In addition, according to any one of the embodiments for solving the problems of the present disclosure, since the multi-communication device includes a plurality of communication modules, high-bit-rate communication can be performed.

In addition, according to any one of the embodiments for solving the problems of the present disclosure, since the multi-communication device includes a plurality of communication modules configured to enable communication based on predetermined circular polarizations, wireless communication can be smoothly performed only through predetermined communication modules despite rotational motions of mechanical units.

Furthermore, according to any one of the embodiments for solving the problems of the present disclosure, by using communication modules disposed within a predetermined range while performing rotational motion, the multi-communication device can increase operational freedom by utilizing wireless communication between devices and can suppress wear between the devices.

The effects that can be obtained from the present disclosure are not limited to the effects mentioned above, and other effects that are not mentioned will be clearly understood by a person having ordinary skill in the art to which the present disclosure pertains from the description below.

Although embodiments of the present disclosure have been described in more detail with reference to the attached drawings, the present disclosure is not necessarily limited to these embodiments, and various modifications may be implemented without departing from the technical spirit of the present disclosure. Therefore, the embodiments of the present disclosure are not intended to limit the technical spirit of the present disclosure but to illustrate the technical idea of the present disclosure, and the technical spirit of the present disclosure is not limited by these embodiments. The scope of protection of the present disclosure should be interpreted based on the appending claims, and all technical ideas within the scope of equivalents should be construed as falling within the scope of the present disclosure.

1. A multi-communication device comprising:
a first mechanical unit;
a second mechanical unit spaced apart from a lower portion of the first mechanical unit and configured to rotate relative to the first mechanical unit;
a first communication module including a first transmitter configured to transmit a signal with a first circular polarization and a first receiver configured to receive a signal with a second circular polarization;
a second communication module including a second transmitter configured to transmit a signal with the second circular polarization and a second receiver configured to receive a signal with the first circular polarization;
a third communication module including a third transmitter configured to transmit a signal with the second circular polarization and a third receiver configured to receive a signal with the first circular polarization; and
a fourth communication module including a fourth transmitter configured to transmit a signal with the first circular polarization and a fourth receiver configured to receive a signal with the second circular polarization,
wherein the first communication module and the third communication module are disposed on the lower portion of the first mechanical unit, and the second communication module and the fourth communication module are disposed on an upper portion of the second mechanical unit.

2. The multi-communication device of claim 1, wherein the first communication module communicates only with the second communication module, and
the third communication module communicates only with the fourth communication module.

3. The multi-communication device of claim 1, wherein at least one pair of communication modules among the first and third communication modules and the second and fourth communication modules are disposed on a single printed circuit board.

4. The multi-communication device of claim 1, wherein communication modules disposed on the same surface of a single mechanical unit are spaced apart from one another by a predetermined separation distance, and
the predetermined separation distance is three to five times a wavelength determined based on a center frequency of the communication modules.

5. The multi-communication device of claim 1, wherein the first mechanical unit performs rotational motion about a central axis that is parallel to a central axis about which the second mechanical unit rotates.

6. The multi-communication device of claim 1, further comprising:
a third mechanical unit spaced apart from a lower portion of the second mechanical unit;
a fifth communication module including a fifth transmitter configured to transmit a signal with the first circular polarization and a fifth receiver configured to receive a signal with the second circular polarization;
a sixth communication module including a sixth transmitter configured to transmit a signal with the second circular polarization and a sixth receiver configured to receive a signal with the first circular polarization;
a seventh communication module including a seventh transmitter configured to transmit a signal with the second circular polarization and a seventh receiver configured to receive a signal with the first circular polarization;
an eighth communication module including an eighth transmitter configured to transmit a signal with the first circular polarization and an eighth receiver configured to receive a signal with the second circular polarization; and
a sidewall disposed along outer peripheries of the first mechanical unit and the third mechanical unit, spaced apart from an outer circumference of the second mechanical unit, and surrounding the second mechanical unit,
wherein the fifth communication module and the seventh communication module are disposed on an upper portion of the third mechanical unit, and the sixth communication module and the eighth communication module are disposed on the lower portion of the second mechanical unit.

7. The multi-communication device of claim 6, wherein each of the second mechanical unit and the third mechanical unit is provided as a plurality of mechanical units.

8. The multi-communication device of claim 6, wherein the sixth communication module is disposed on a lower surface of the second mechanical unit at a position corresponding to the second communication module, and
the eighth communication module is disposed on the lower surface of the second mechanical unit at a position corresponding to the fourth communication module.

9. The multi-communication device of claim 6, wherein the first communication module communicates only with the second communication module,
the third communication module communicates only with the fourth communication module,
the fifth communication module communicates only with the sixth communication module, and
the seventh communication module communicates only with the eighth communication module.

10. The multi-communication device of claim 6, wherein at least one pair of communication modules among the first and third communication modules, the second and fourth communication modules, the fifth and seventh communication modules, and the sixth and eighth communication modules are disposed on a single printed circuit board.
